(19) United States
(12) Patent Application Publication
(10) Pub. No.: US 2024/0226950 A1
(43) Pub. Date: Jul. 11, 2024

(54) Smart Automated Spin Coater

(71) Applicant: North Carolina State University, Raleigh, NC (US)

(72) Inventors: Aram AMASSIAN, Raleigh, NC (US); Nathaniel R. WOODWARD, Raleigh, NC (US); Boyu GUO, Raleigh, NC (US)

(73) Assignees: North Carolina State University, Raleigh, NC (US); North Carolina State University, Raleigh, NC (US)

(21) Appl. No.: 18/236,256

(22) Filed: Aug. 21, 2023

Related U.S. Application Data
(60) Provisional application No. 63/399,542, filed on Aug. 19, 2022.

(51) Int. Cl. B05C 11/08; B05D 1/00

(52) U.S. Cl. CPC B05C 11/08; B05D 1/005

(57) ABSTRACT

Spin coating systems and methods. In one aspect, a spin coater assembly is provided. The spin coater assembly includes a spinner configured for receiving a substrate thereon, a plurality of material dispensers, an arm assembly configured to selectively position one of the plurality of material dispensers over the substrate, and a controller in communication with each of the spinner, the plurality of material dispensers, and the arm assembly.

### PRIORITY CLAIM

This application claims the priority benefit of U.S. Provisional Patent Application Ser. No. 63/399,542, filed Aug. 19, 2022, the disclosure of which is incorporated herein by reference in its entirety.

### GOVERNMENT INTEREST

This invention was made with government support under grant number N00014-20-1-2573 awarded by the Office of Naval Research and under grant number CBET1934351 awarded by the National Science Foundation. The government has certain rights in the invention.

### TECHNICAL FIELD

The subject matter disclosed herein relates generally to systems and methods for applying materials onto a surface of a substrate. More particularly, the subject matter disclosed herein relates to spin coating systems and methods for achieving uniform thin films.

### BACKGROUND

Spin coating is a widely used coating method to achieve uniform thin films of materials, often polymers, onto the surface of a substrate by employing the concept of centrifugal force. Although such methods are easy to use, safe, and inexpensive for many applications where high quality layers are required, there exists a need for spin coating systems and methods that can provide precise and reproducible thin-film fabrication.

### SUMMARY

In accordance with this disclosure, spin coating systems and methods are provided. In one aspect, a spin coater assembly is provided. The spin coater assembly includes a spinner configured for receiving a substrate thereon, a plurality of material dispensers, an arm assembly configured to selectively position one of the plurality of material dispensers over the substrate, and a controller in communication with each of the spinner, the plurality of material dispensers, and the arm assembly.

In another aspect, a method for applying a coating to a substrate includes positioning a substrate on a spinner, selectively operating an arm assembly to position one of a plurality of material dispensers over the substrate, and dispensing material from the one of the plurality of material dispensers to the substrate. The steps of selectively positioning the one of the plurality of material dispensers and dispensing material are controlled by a controller in communication with each of the spinner, the plurality of material dispensers, and the arm assembly.

In another aspect, a non-transitory computer readable medium storing executable instructions that when executed by at least one processor of a computer control the computer to perform operations comprising selectively rotating a spinner on which a substrate is positioned; selectively operating an arm assembly to position one of a plurality of material dispensers over the substrate; and dispensing material from the one of the plurality of material dispensers to the substrate.

The subject matter described herein can be implemented in software in combination with hardware and/or firmware. As such, the term “platform” as used herein refers to hardware, which may also include software and/or firmware components, for implementing the feature being described. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

Although some of the aspects of the subject matter disclosed herein have been stated hereinabove, and which are achieved in whole or in part by the presently disclosed subject matter, other aspects will become evident as the description proceeds when taken in connection with the accompanying drawings as best described hereinbelow.

### BRIEF DESCRIPTION OF DRAWINGS

FIG. 1 is a block diagram of an example device for characterization of samples;

FIG. 2A is a block diagram of an example characterization system;

FIG. 2B is a block diagram of a platform for characterization including the characterization system;

FIG. 2C is a block diagram showing alternative hardware configurations for a material deposition system;

FIG. 2D is a block diagram illustrating a system for nitrogen (or other gas) blowing;

FIG. 2E is an image showing an example of heated nitrogen blowing;

FIG. 2F is a block diagram of an example system with a heated substrate for hot casting;

FIG. 2G is an image of an example system with a spinner and an IR lamp highlighted by a rectangular box;

FIG. 2H is a block diagram of a parallel spin coating example setup with multiple spinners;

FIG. 3 is a waveform diagram showing a first waveform of UV for photoluminescence, a second waveform for a broadband LED, and the spectrometer;

FIG. 4A is picture of an example implementation of the device where the probe is rotatable from spinner to over hotplate;

FIG. 4B is a picture of an example implementation of the device in a stationary probe setup;

FIG. 4C is a picture of an example implementation showing the broader platform of the system;

FIG. 5 is a block diagram of a system that incorporates the device and a machine learning module;

FIGS. 6A-6G illustrate various components of a spin coater system;

FIGS. 7A-7C show example implementations of the system;

FIGS. 8A-8B illustrate example use cases of the system; and

FIG. 9 is a flow diagram of an example method for applying a coating to a substrate.

### DETAILED DESCRIPTION

The presently disclosed subject matter provides a modular, 3D-printed computer-controlled spin coater. In some embodiments, a brushless DC motor is connected to a speed controller that is configured to control the speed of rotation. A substrate (e.g., 15 by 15 mm glass or standard 100 mm wafers) can be positioned for rotation with the motor, such as by mounting the substrate to a vacuumless spinner chuck. In some embodiments, the spinner chuck includes one or more features that are configured to receive substrates having any of a variety of shapes and/or sizes and hold the substrates by fit in a substantially center position with respect to the axis of rotation of the motor. In some embodiments, the poles of the spinner chuck are designed to have particular heights, so that the vibration of substrate is limited during high-speed spinning and liquid dispensing.

In some embodiments, the spinner is integrated with a plurality of computer-controlled material dispensers, including but not limited to syringe pumps, automated material mixers, or other liquid handlers. In some embodiments, for example, up to 99 syringe pumps can be selectively operated.

A computer-controlled retractable arm module can be coupled to the spinner to deposit material from a selected material dispenser over the substrate. In some embodiments, for example, the arm is configured to align the material dispenser with a center of the substrate. In some embodiments, for example, the arm is configured and mechanically calibrated to align the material dispenser with a center of the substrate. In some embodiments, the arm module can be 3D printed. In some embodiments, each material dispenser can include an outlet that can be positioned in proximity to the substrate, including but not limited to a tube having a first end in communication with each liquid handler and having an outlet at a second end coupled to the arm module near the spinner. In some embodiments, the arm assembly includes a servo configured to rotate the outlet of the selected material dispenser into a position over the substrate.

In addition, in some embodiments, a gas inlet can be provided in communication with the spinner. The gas inlet can be operable to maintain a steady processing environment (e.g., regulate relative humidity, maintain positive pressure environment), evacuate solvents, and/or blow small particles away. In some embodiments, for example, the gas inlet is configured to supply nitrogen or argon gas to the processing environment.

In some embodiments, one or more sensors are positioned near the spinner to collect characterization data from material on the substrate. The characterization data can be assigned to uniquely identified samples. In some embodiments, for example, collecting characterization data can include obtaining measurements of UV-Vis reflectance absorbance and/or modular photoluminescence, Grazing-Incidence Wide-Angle X-ray Scattering (GIWAXS) optical and/or electron microscopy, Raman microscopy, x-ray diffraction, and/or electrical characterization, among others. In addition, a camera can be positioned near the spinner for capturing photographs or videos of the process. In some embodiments, collecting characterization data can include constructing a database, either locally or on the cloud, to enable data analytics and visualization. In addition, in some embodiments, the characterization data can be used to guide future experiments manually, automatically, semi-autonomously, or autonomously by applying statistical, machine-learning, or artificial intelligence algorithms. Examples of such experiments can include uncertainty quantification, feature extraction, intelligent exploration of parameter space, exploitation and multi-parameter optimization, closed-loop experimentation with decision making under uncertainty, and semi-autonomous and autonomous experimentation.

All electronic hardware can be synchronized via a single software program (e.g., a python program). Further, in some embodiments, the software program can present a simple to use graphical user interface for the users to input their experimental recipe along with outputting a log of the experiment and the timing of each event. Such a fully integrated spinner with material delivery ensures precise and reproducible thin-film fabrication. Parameters that can be controlled can include spinner rpm, spinner ramp rate, multiple spinner speeds and stop/start processing, deposition volume, deposition rate, and precise deposition timing. In this way, the single system can be used to automatically formulate inks with integrated spin coating and characterization, all of which can be driven by a common controller and a single software product.

This technology can provide a closed-loop experimental platform driven by machine learning and artificial intelligence which enables rapid failure prototyping and can decrease the time and cost to bring new technology innovations to market. The technology enables quicker development cycles and exploration of a vast parameter space in a fraction of the time. For example, the present spin coater can be used for rapid prototyping in a number of fields including energy devices (e.g., batteries, solar, electrochromics), semiconductor fabrication, and other application or functional devices that require a coating.

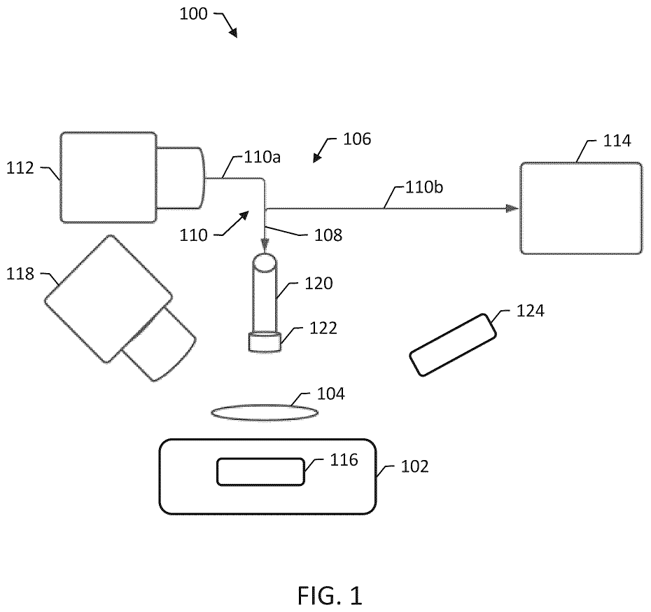

FIG. 1 is a block diagram of an example device 100 for characterization of samples. The device 100 includes a substrate 102 configured for receiving a sample 104 thereon. The device 100 is configured for characterizing the sample 104.

The device 100 includes an optical fiber probe 106 having a first end 108 positioned near the sample 104 and a second end 110 that is bifurcated to include one or more first fibers 110a configured for connection to a first light emitting device 112 and one or more second fibers 110b configured for connection to a spectrometer 114. The device 100 includes a reflectance module 116 coupled to the substrate 102 and a second light emitting device 118 positioned near the sample 104.

The optical fiber probe 106 is configured for selectively obtaining, at the spectrometer 114, both a reflectance absorbance measurement of the sample 104 associated with the first light emitting device 112 and a photoluminescence measurement of the sample 104 associated with the second light emitting device 114.

In some examples, the substrate 102 is mounted on a rotating element of a spin coater device, and the reflectance module 116 is attached to the rotating element. The sample 104 can be, e.g., a thin film, a bulk surface, a bulk material, a biological material, a solid-state material, or any combination thereof.

The first light emitting device 112 can be a broadband light source configured to produce light in wavelengths within the UV-Vis region of the electromagnetic spectrum. The second light emitting device 118 can be adjustable to emit multiple excitation wavelengths.

In some examples, the device 100 includes a controller in communication with the first light emitting device 112 and the second light emitting device 118 for controlling activation of the first light emitting device 112 and the second light emitting device 118. The device 100 can include a graphical user interface configured to display the reflectance absorbance measurement and the photoluminescence measurement in real time.

The device 100 can include a fiber probe holder 120 and a filter 122. The filter 122 can be, e.g., a 400 nm optical filter. The fiber probe holder 120 is situated to orient the optical fiber probe 106 to an appropriate viewing position with respect to the sample 104.

In general, the device 100 can be used for diffuse or specular reflectance from solids; fluorescence; color. The fibers in the optical fiber probe 106 can be high OH UV-Visible fibers (e.g., 300-1100 nm). In some examples, the optical fiber probe 106 includes a 6-around-1 fiber bundle design, with a six fiber leg connecting to the light source 112 and a single-fiber leg connecting to the spectrometer 114. Other numbers of fibers can be used as appropriate.

In some examples, the device 100 includes a camera 124 configured for capturing one or more images of the sample 104 during an experiment. The camera 124 can be configured to transmit the images, e.g., to a user computer, for display to technician or for supplying the images to a machine learning algorithm.

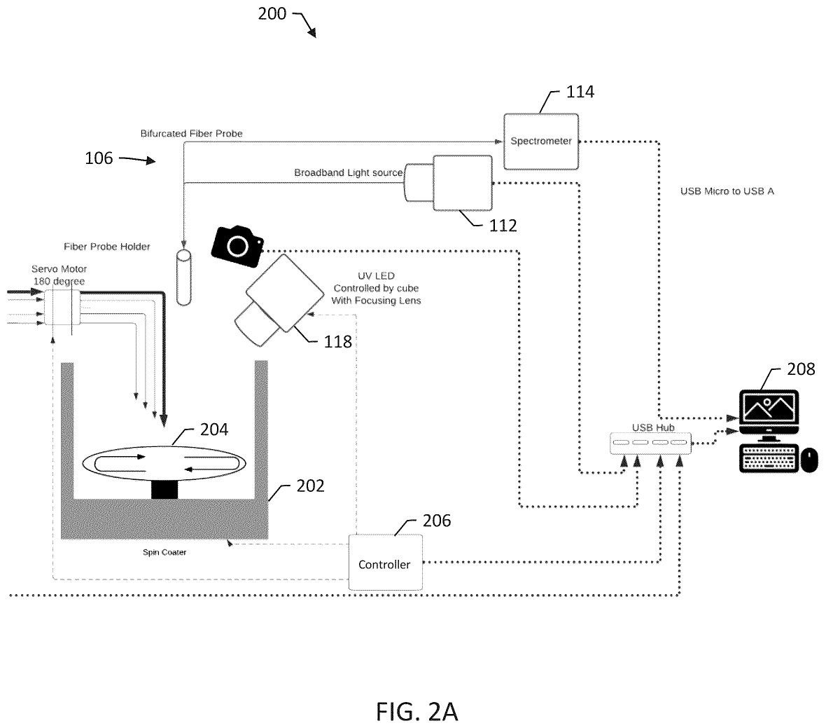

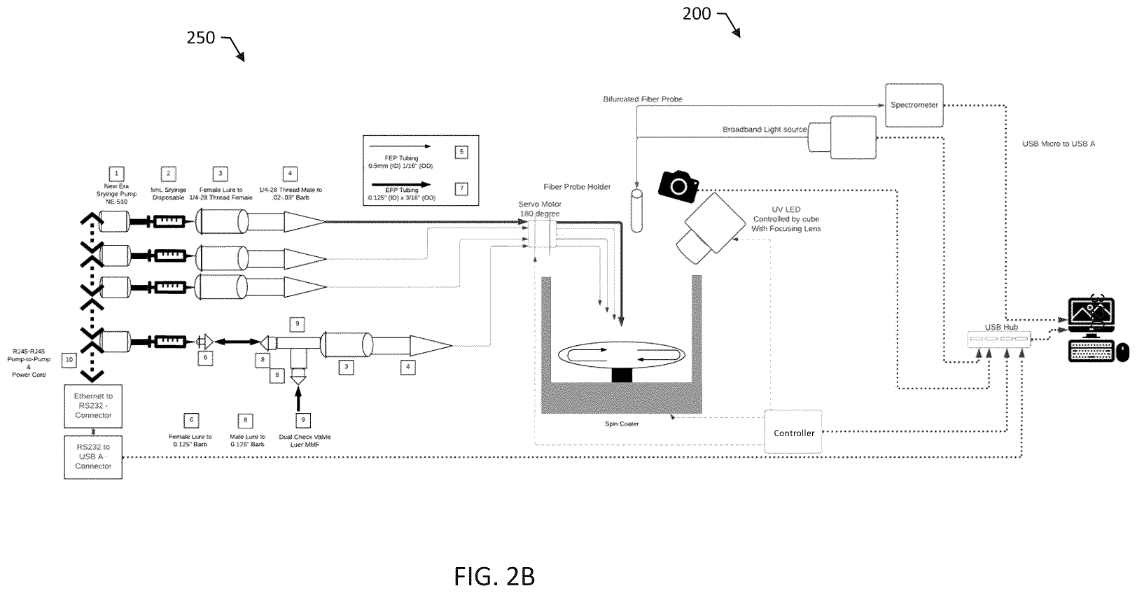

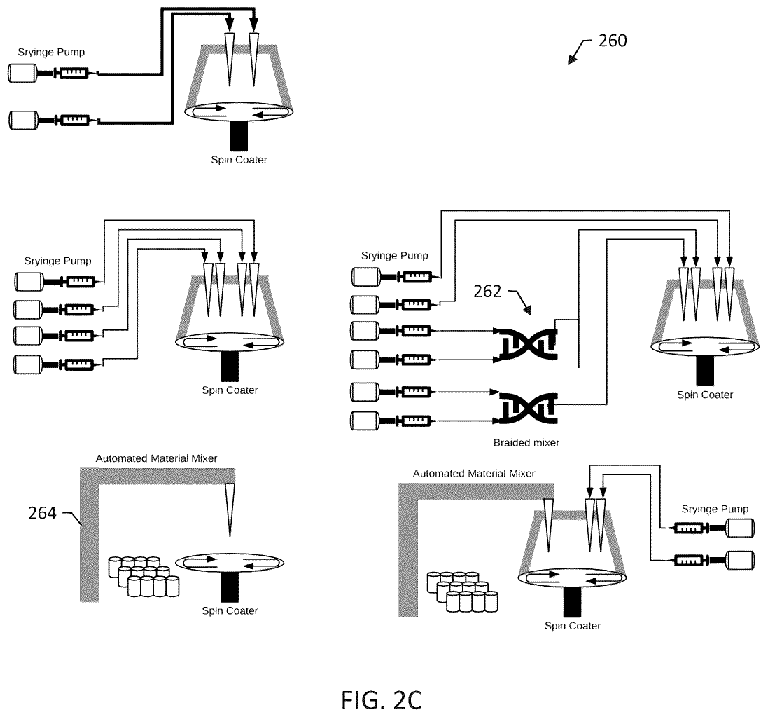

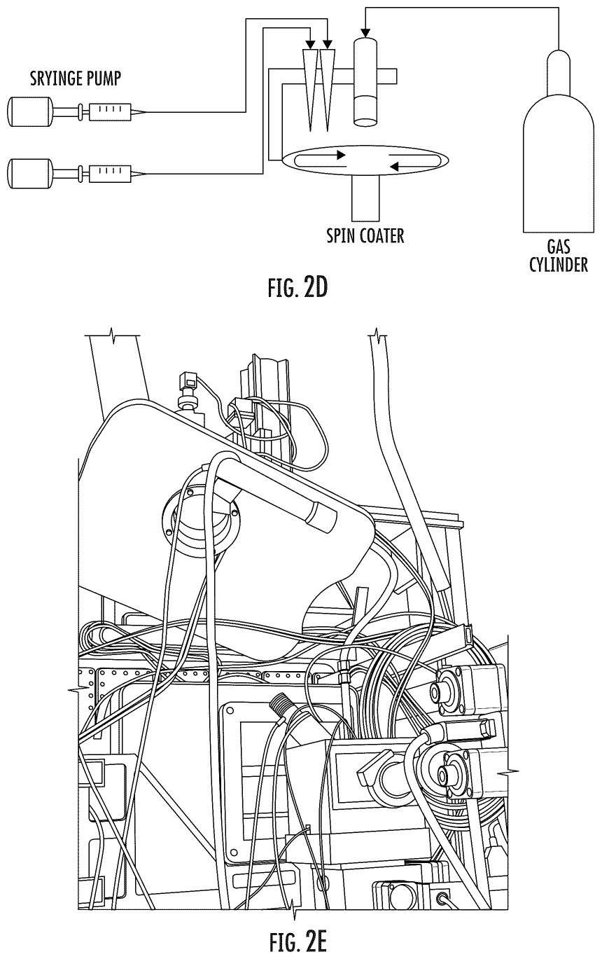

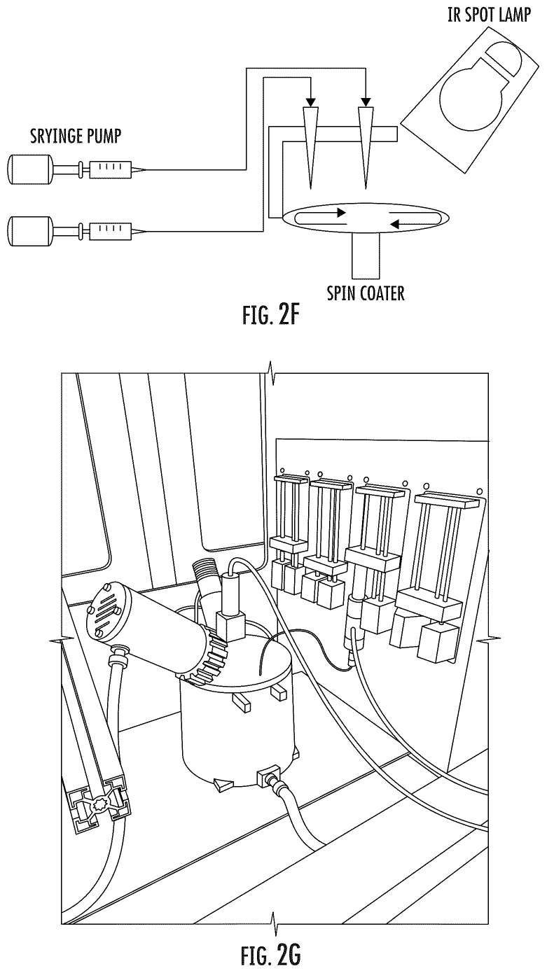

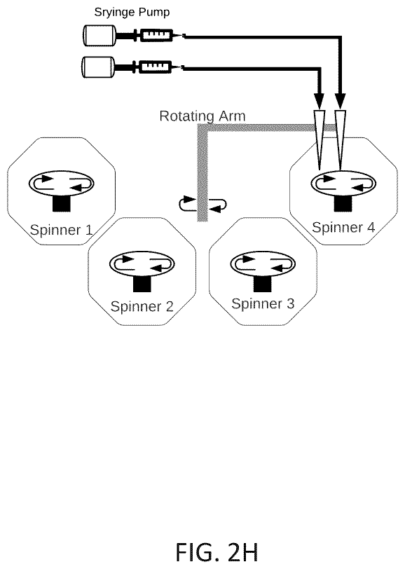

FIG. 2A is a block diagram of an example characterization system 200 including the device 100 of FIG. 1. FIG. 2A illustrates a spin coater device 202; the substrate 102 can be mounted on a rotating element 204 of the spin coater device 202. The reflectance module 116 can also be attached to the rotating element 204.

The system 200 includes a controller 206 configured for controlling activation of the light emitting devices 112 and 118. The controller 206 can be, e.g., a microcontroller or other appropriate computing device. The system 200 also includes a user computer 208 which can include a graphical user interface configured to display reflectance absorbance measurements and photoluminescence measurements, e.g., in real time. In some examples, the graphical user interface is configured to receive user input to set one or more experiment parameters, for example, rotations per minute (RPM), dispense volume and rate, spin time, and so on.

FIG. 2B is a block diagram of a platform for characterization including the characterization system 200 of FIG. 2A and a sample deposition system 250 configured for loading the sample 104 onto the spin coater device 202 for characterization. The sample deposition system 250 can include, for example, a plurality of electronically controllable syringe pumps, appropriate tubing, and a servo motor controlled by the controller 206.

FIG. 2C is a block diagram showing alternative hardware configurations 260 for a material deposition system. For example, a material deposition system can include, e.g., one or more braided mixers, or an automated material mixer 264. FIG. 2D is a block diagram illustrating a system for nitrogen (or other gas) blowing.
In addition to solutions being dispensed by a syringe pump, a nitrogen tube can replace or is added to one of the selectable tubing outlets that the rotating arm can position over the spinner.
The system can turn the gas on/off via a computer-controlled solenoid valve.
Control over the rate of gas via a flow meter or computer controlled.
Can heat the gas using an electronic resistive heater from 25 to 250c. Heating can be integrated into the control software.
Gas tubing can be position either straight down or at an angle.
Can be used to fill the spinner chamber with a positive nitrogen flow to create a high nitrogen atmosphere for a few experiments that require a low humidity environment. In some examples, there is a separate inlet positioned at the bottom of the spinner for creating a positive pressure/low humidity chamber.

FIG. 2E is an image showing an example of heated nitrogen blowing. The heater and gas outlet are directly above the spinner as highlighted by the rectangular boxes. Tubing connects to in-house nitrogen, through the heater, and delivers the gas directly onto the substrate. In the example shown in FIG. 2E, there is an on/off valve to control the gas, and the valve can be turned on, e.g., at a specific time for a given experiment to quench the film on the substrate.

FIG. 2F is a block diagram of an example system with a heated substrate for hot casting.
Taking a substrate from a hotplate to the spinner and starting spinning allows for the normally glass substrate to cool down.
An IR lamp and or heated gas, or other suitable heat source as would be apparent to one of ordinary skill in the art upon a review of the instant disclosure, can be used to preheat the substrate to a specific temperature before despising the solution to reduce heat loss while transferring the substrate.
Temperature can be computer-controlled over a temperature ranging from about 25° C. to about 200° C.
Temperature ramp rate is also computer-controlled.

FIG. 2G is an image of an example system with a spinner and an IR lamp highlighted by a rectangular box.

FIG. 2H is a block diagram of a parallel spin coating example setup with multiple spinners and a centralized rotating arm drawing from a common set of syringes/solutions.
Using the same arm system to move back and forth between different tubing for one spinner, it can rotate further to cover multiple spinners attached to one another in a circular patterning.
A single rotating arm and syringe pump(s) can then allow the spinners to run batch processing drawing from the same stock solution.
Multiple syringes with varied solutions provide for running different material experiments on different spinners in parallel to prevent cross contaminations.
Rotating arm is good for solution dispensing via syringe pumps and/or nitrogen/gas blowing.

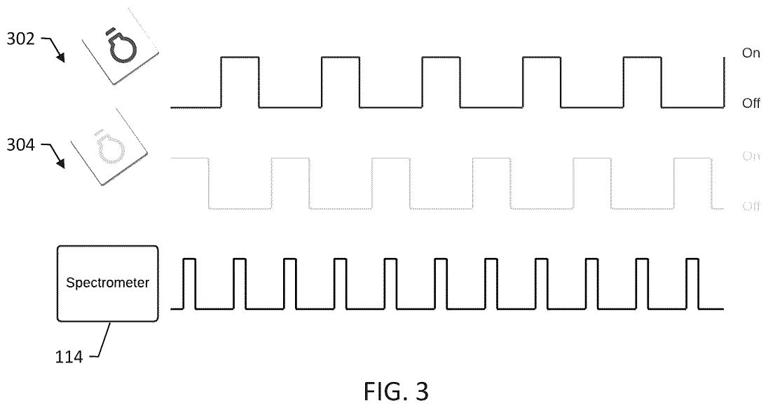

FIG. 3 is a waveform diagram showing a first waveform 302 of UV for photoluminescence, a second waveform 304 for a broadband LED, and the spectrometer 114.

The device 100 can include one or more of the following characterization add-ons, which can be used in-situ and ex-situ:
Camera configured for capturing photographs or videos of the process
Reflectance measurements:
   Absorbance and optical thickness measurements
      UV-Vis light source
      Spectrometer
      Bifurcated fiber probe
Photoluminescence
   Provides band gap and relative quantum yield measurements
      Add appropriate excitation wavelength LED

For the photoluminescence light source, any appropriate light producing technology can be used. For example, an LED or a laser diode can be used. For the photoluminescence quantum yield (PLQY), this value can be calculated from the combined measurements of both UV-Vis absorbance and photoluminescence.

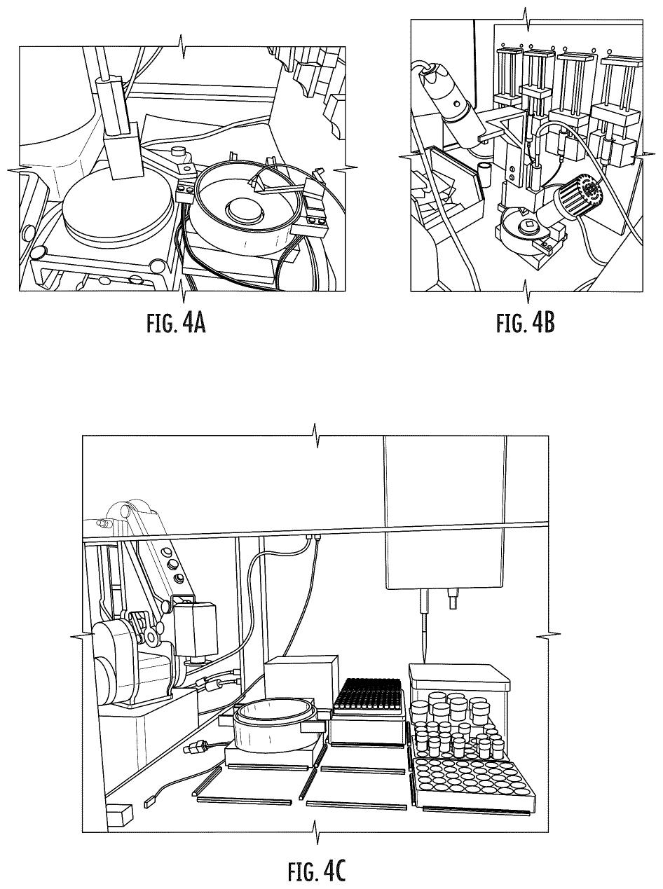

The device 100 can optionally have a movable measurement probe or a stationary probe setup. The probe could also be attached at, e.g., a 3 or more axis arm. FIG. 4A is picture of an example implementation of the device 100 where the probe is rotatable from spinner to over hotplate. FIG. 4B is a picture of an example implementation of the device 100 in a stationary probe setup. FIG. 4C is a picture of an example implementation showing the broader platform of the system.

The device 100 can be used in a wide range of use cases, for example:
OPV thin-film in-situ study
OPV device fabrication
Perovskite thin-film in-situ study
Perovskite device fabrication
Perovskite Quantum Dot fabrication
In-Line GIWAXs in-situ study
Ex-Situ characterization

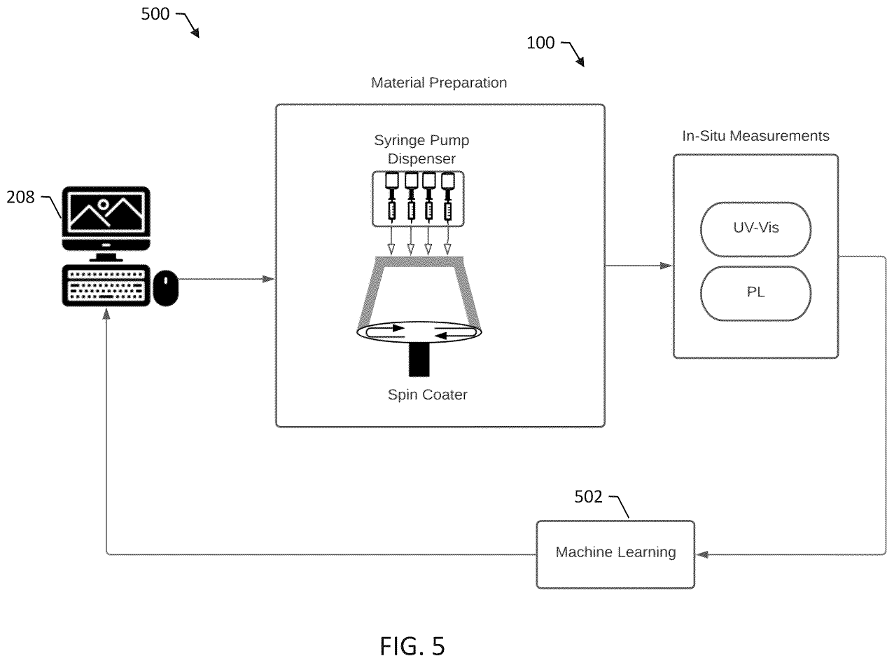

FIG. 5 is a block diagram of a system 500 that incorporates the device 100 and a machine learning module 502. The machine learning module 502 can be implemented on a system of one or more computers configured for receiving training data (e.g., from the device 100 and optionally other sources) and producing a machine learning model for characterizing samples, e.g., which can be reported on the user computer 208. In some examples, the system 500 uses active learning by utility equation optimization in-situ.

In some embodiments, photoluminescence (PL), UV-Vis, and pictures are all collected in-line, providing for immediate decisions to be made following machine learning (ML) or artificial intelligence (AI) algorithms, rather than having to proceed to another characterization platform. Alternatively or additionally, in some embodiments, just UV-Vis, just PL, or a combination of both can be analyzed and the values of interest used for ML/AI algorithms. A camera can also be used for machine vision on the films, which is then used for the ML/AI optimization algorithms.

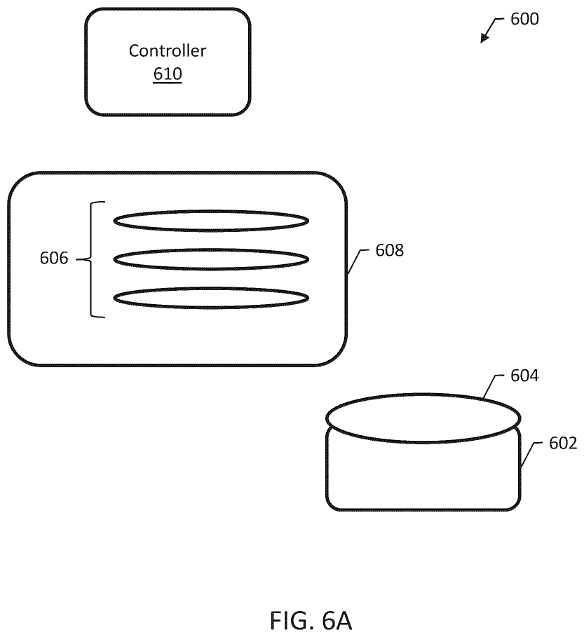

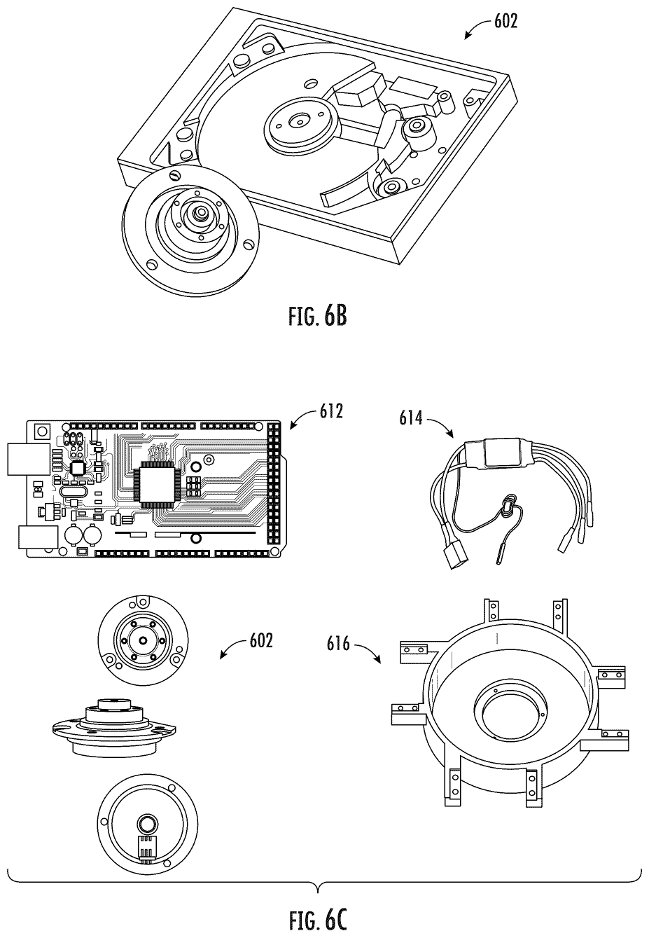

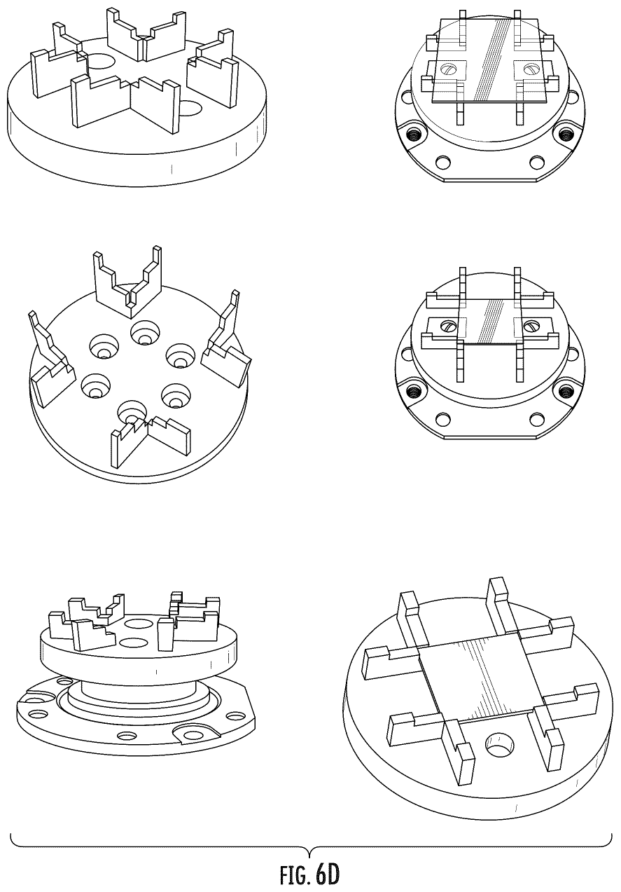

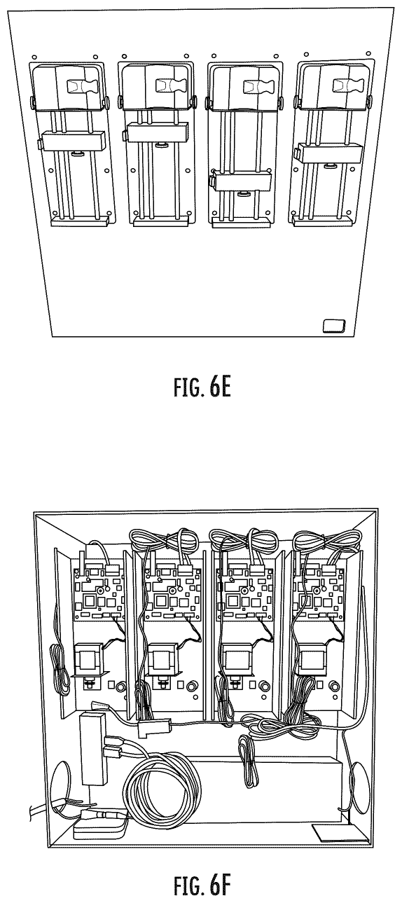

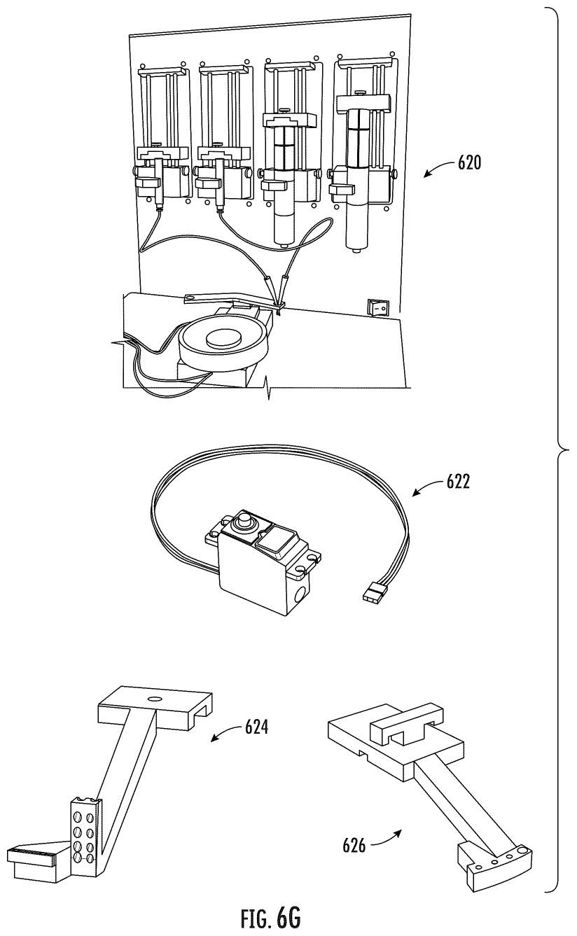

FIGS. 6A-6G illustrate various components of a spin coater system.

FIG. 6A is a block diagram of an example spin coater assembly 600. The spin coater assembly 600 includes a spinner 602 configured for receiving a substrate 604 thereon. The spin coater assembly 600 includes a number of material dispensers 606. The spin coater assembly 600 includes an arm assembly 608 configured to selectively position one of the material dispensers 606 over the substrate 604. The spin coater assembly 600 includes a controller 610 in communication with each of the spinner 602, the material dispensers 606, and the arm assembly 608.

The spinner 602 can be, e.g., a spinner chuck configured to receive the substrate 604. The material dispensers 606 can be, e.g., liquid handlers that each include an outlet coupled to the arm assembly 608. The liquid handlers can be syringe pumps, automated material mixers, or other devices suitable for dispensing material.

The arm assembly 608 can include a servo configured to rotate the one of the material dispensers 606 into a position over the substrate 604. The spin coater assembly 600 can include a gas inlet in communication with the spinner 602 and configured to maintain a desired processing environment at the substrate.

The spin coater assembly 600 can include one or more sensors positioned near the spinner 602 and configured for collecting characterization data from material on the substrate. The one or more sensors can be configured for obtaining measurements of UV-Vis reflectance absorbance and/or modular photoluminescence of material on the substrate 604.

FIG. 6B is a picture of an example motor taken from a spinning disk hard drive 602 for an automated spin coater. In some examples, the spinner 602 is configured, by appropriate selection of components, for spin coating from 500 to 10,000 rotations per minute. The spinner 602 can be kept level, e.g., for use in GIWAX and in-situ curvature. The spinner 602 can accommodate a variety of substrate sizes, e.g., 1.5 cm and 1 in; up to 100 mm or more.

FIG. 6C shows various examples of components of the spin coater assembly 600 of FIG. 6A. FIG. 6C shows an example controller 612, an example speed controller 614, an example brushless DC motor 602, and an example 3D printed, modular spinner housing 616.

FIG. 6D includes pictures of an example vacuumless spinner chuck, which can accommodate 1.5 cm and 1 in glass substrates.

FIG. 6E shows an example material deposition system including syringe pumps. In this example, the system can run multiple pumps, e.g., up to 100, at precise volumes and flow rate. To achieve good films, especially with dynamic dripping, it can be useful to dispense solution in the middle of the substrate. A servo rotates the corresponding syringe tube for the pump that is selected to dispense over the center of the substrate. The servo can be swapped out to handle multiple end attachments.

FIG. 6F shows an example syringe pump box configured for wire management. The box can be manufactured, e.g., by laser-cutting out of acrylic. The box can house, for example, syringe pumps, electronics (e.g., microcontroller, motor speed controller, relays for turning gases on/off), communications hub (e.g., USB hub for microcontroller, camera, broadband LED, and syringe pumps), and a power supply. A power switch can be located, e.g., on the front of the box.

FIG. 6G illustrates example components of the material deposition system. FIG. 6G shows example syringe pumps 620, an example servo motor 622, and examples of syringe tube holders 624 and 626. The syringe tube holders 624 and 626 can be manufactured, e.g., by 3D printing.

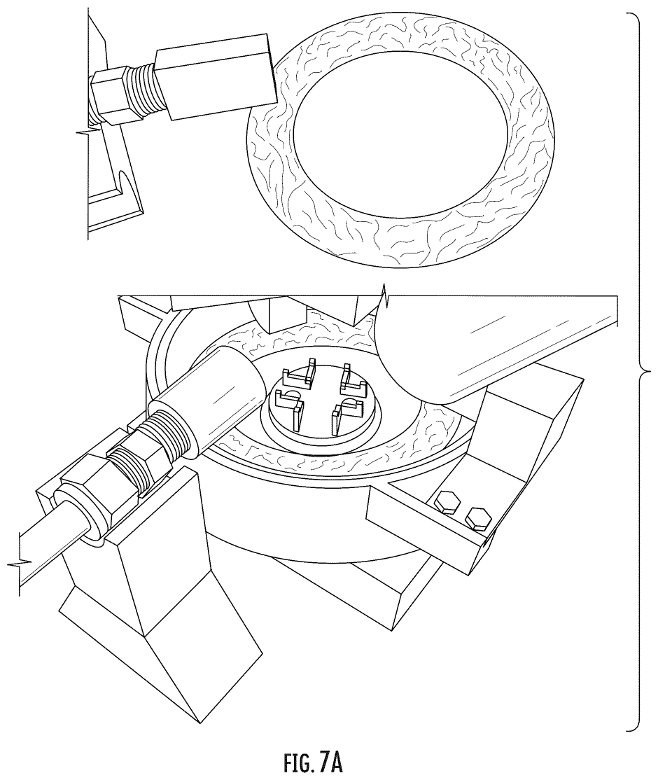

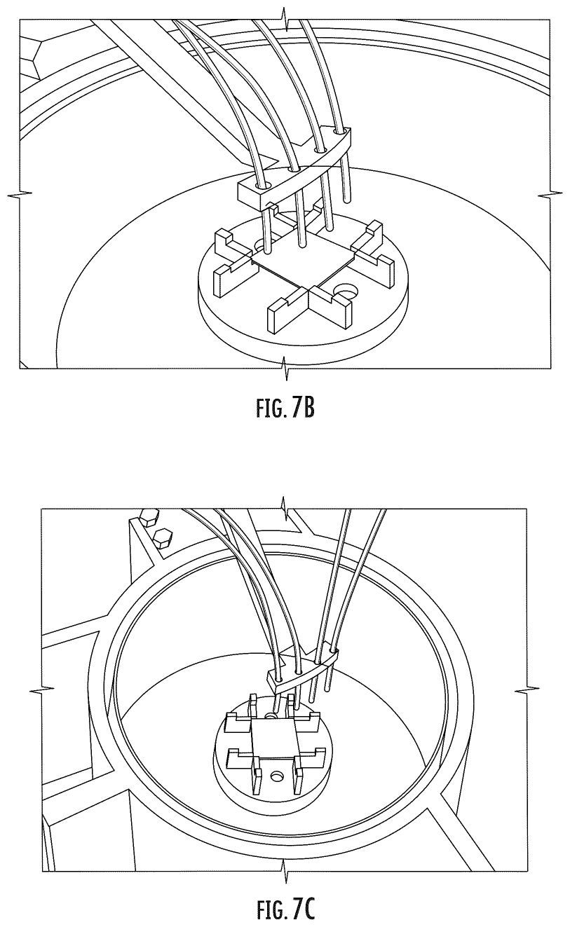

FIGS. 7A-7C show example implementations of the system. FIG. 7A shows pictures of an example humidity control system that uses nitrogen blowing. The system includes a nitrogen inlet that maintains a steady processing environment, e.g., humidity down to 10% RH. The system can evacuate the chamber of solvents and power small particles away, e.g., using positive pressure. The system can allow for precise control of exchanges per minute with the use of a flowmeter. FIG. 7B shows a picture of an example material deposition. FIG. 7C shows a picture of a demonstration of a dispensing center alignment using an automated spin coater.

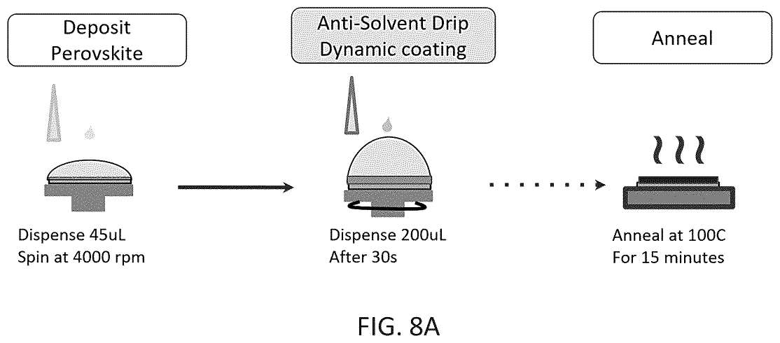

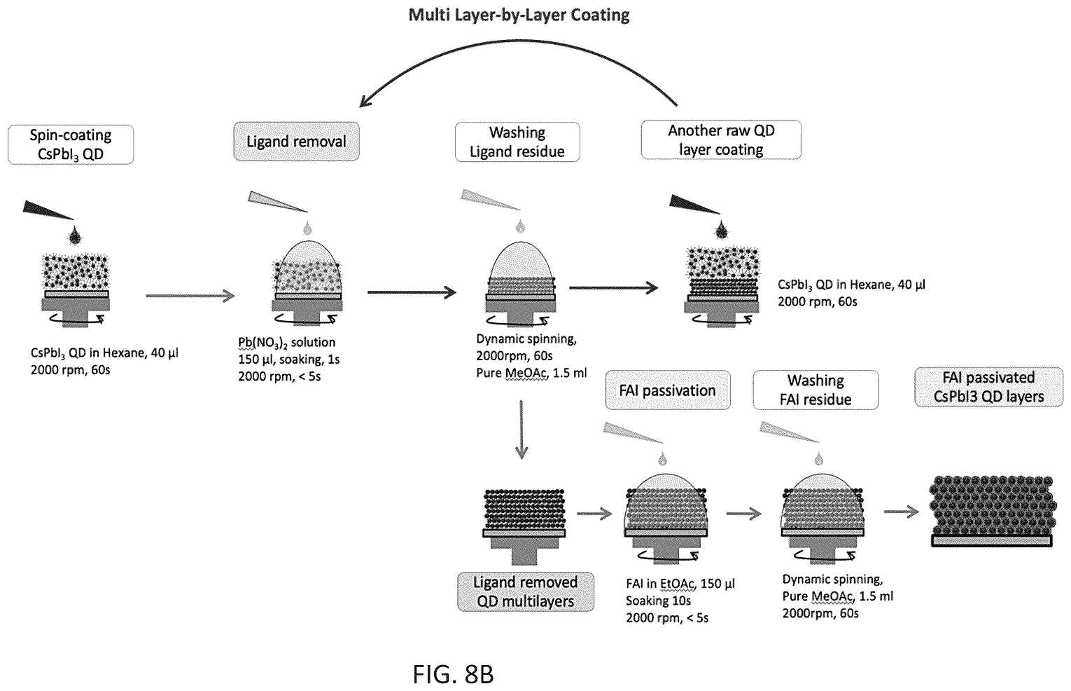

FIGS. 8A-8B illustrate example use cases of the system. FIG. 8A is a block diagram of an example use case for perovskite thin-film fabrication. As shown in FIG. 8A, the process includes depositing perovskite, performing an anti-solvent drip dynamic coating, and then annealing. FIG. 8B is a block diagram of another example use case for creating a perovskite quantum-dot. As shown in FIG. 8B, the process includes multi layer-by-layer coating by repeatedly adding raw quantum dot layer coatings and performing ligand removal.

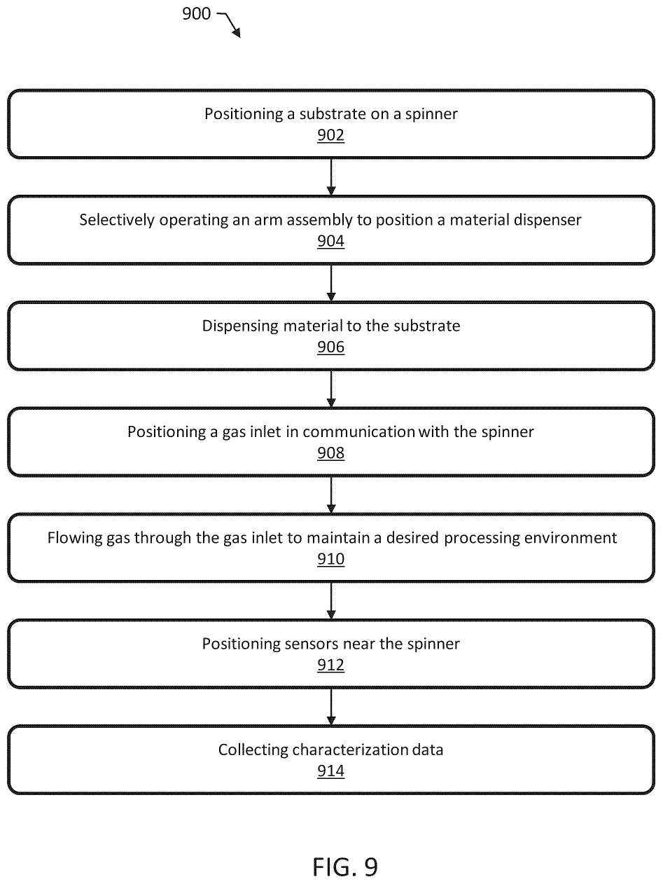

FIG. 9 is a flow diagram of an example method 900 for applying a coating to a substrate.

The method 900 includes positioning a substrate on a spinner (902). Positioning the substrate on the spinner can include engaging the substrate with a spinner chuck coupled to the spinner.

The method 900 includes selectively operating an arm assembly to position one of a number of material dispensers over the substrate (904). The material dispensers can include liquid handlers that each include an outlet coupled to the arm assembly. Selectively operating the arm assembly can include operating a servo to rotate the one of the material dispensers into a position over the substrate.

The method 900 includes dispensing material from the one of the material dispensers to the substrate (906). Selectively positioning the one of the material dispensers and dispensing material are controlled by a controller in communication with each of the spinner, the material dispensers, and the arm assembly.

In some examples, the method 900 includes positioning a gas inlet in communication with the spinner (908) and flowing gas through the gas inlet to to assist in drying the film/removing solvent (910). The method 900 can also include heating the gas, e.g., to a specified temperature. In some examples, the method 900 includes positioning one or more sensors near the spinner (912) and collecting characterization data from material on the substrate and assigning the characterization data to uniquely identified samples (914).

Collecting characterization data can include constructing a database, either locally or on the cloud, to enable data analytics and visualization. The characterization data can be used to guide one or more experiments manually, automatically, semi-autonomously, or autonomously by applying statistical, machine-learning, or artificial intelligence algorithms. The experiments can include, e.g., uncertainty quantification, feature extraction, intelligent exploration of parameter space, exploitation and multi-parameter optimization, closed-loop experimentation with decision making under uncertainty, and semi-autonomous and autonomous experimentation.

Unless defined otherwise, all technical and scientific terms used herein have the same meaning as commonly understood to one having ordinary skill in the art to which the presently disclosed subject matter belongs. Although, any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in this application, including the claims. Thus, for example, reference to “a vial” can include a plurality of such vials, and so forth. Unless otherwise indicated, all numbers expressing quantities of length, diameter, width, and so forth used in the specification and claims are to be understood as being modified in all instances by the terms “about” or “approximately”. Accordingly, unless indicated to the contrary, the numerical parameters set forth in this specification and attached claims are approximations that can vary depending upon the desired properties sought to be obtained by the presently disclosed subject matter.

As used herein, the terms “about” and “approximately,” when referring to a value or to a length, width, diameter, temperature, time, volume, concentration, percentage, etc., is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate for the disclosed apparatuses and devices.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

The term “comprising”, which is synonymous with “including” “containing” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising”, “consisting of”, and “consisting essentially of”, where one of these three terms is used herein, the presently disclosed and claimed subject matter can include the use of either of the other two terms.

As used herein, the term “and/or” when used in the context of a listing of entities, refers to the entities being present singly or in combination. Thus, for example, the phrase “A, B, C, and/or D” includes A, B, C, and D individually, but also includes any and all combinations and sub-combinations of A, B, C, and D.

The presently disclosed subject matter can be embodied in other forms without departure from the spirit and essential characteristics thereof. The embodiments described therefore are to be considered in all respects as illustrative and not restrictive. Although the present subject matter has been described in terms of certain preferred embodiments, other embodiments that are apparent to those of ordinary skill in the art are also within the scope of the present subject matter.

What is claimed is:

1. A spin coater assembly comprising:
a spinner configured for receiving a substrate thereon;
a plurality of material dispensers;
an arm assembly configured to selectively position one of the plurality of material dispensers over the substrate; and
a controller in communication with each of the spinner, the plurality of material dispensers, and the arm assembly.

2. The spin coater assembly of claim 1, wherein the spinner comprises a spinner chuck configured to receive the substrate, and wherein the plurality of material dispensers comprises a plurality of liquid handlers that each include an outlet coupled to the arm assembly.

3. The spin coater assembly of claim 2, wherein the plurality of liquid handlers comprises one or more syringe pumps or one or more automated material mixers.

4. The spin coater assembly of claim 1, comprising an infrared spot lamp configured for preheating the substrate.

5. The spin coater assembly of claim 1, wherein the arm assembly comprises a servo configured to rotate the one of the plurality of material dispensers into a position over the substrate.

6. The spin coater assembly of claim 1, comprising a gas inlet in communication with the spinner and configured to maintain a desired processing environment at the substrate.

7. The spin coater assembly of claim 1, comprising one or more sensors positioned near the spinner and configured for collecting characterization data from material on the substrate.

8. The spin coater assembly of claim 7, wherein the one or more sensors are configured for obtaining measurements of UV-Vis reflectance absorbance and/or modular photoluminescence of material on the substrate.

9. A method for applying a coating to a substrate, the method comprising:
positioning a substrate on a spinner;
selectively operating an arm assembly to position one of a plurality of material dispensers over the substrate; and
dispensing material from the one of the plurality of material dispensers to the substrate;
wherein selectively positioning the one of the plurality of material dispensers and dispensing material are controlled by a controller in communication with each of the spinner, the plurality of material dispensers, and the arm assembly.

10. The method of claim 9, wherein positioning the substrate on the spinner comprises engaging the substrate with a spinner chuck coupled to the spinner.

11. The method of claim 9, wherein the plurality of material dispensers comprises a plurality of liquid handlers that each include an outlet coupled to the arm assembly.

12. The method of claim 9, wherein selectively operating the arm assembly comprises operating a servo to rotate the one of the plurality of material dispensers into a position over the substrate.

13. The method of claim 9, comprising:
positioning a gas inlet in communication with the spinner; and
flowing gas through the gas inlet.

14. The method of claim 9, comprising:
positioning one or more sensors positioned near the spinner; and
collecting characterization data from material on the substrate and assigning the characterization data to uniquely identified samples.

15. The method of claim 14, wherein collecting characterization data comprises constructing a database, either locally or on the cloud, to enable data analytics and visualization.

16. The method of claim 14, comprising using the characterization data to guide one or more experiments manually, automatically, semi-autonomously, or autonomously by applying statistical, machine-learning, or artificial intelligence algorithms.

17. The method of claim 16, wherein the one or more experiments are selected from the group consisting of uncertainty quantification, feature extraction, intelligent exploration of parameter space, exploitation and multi-parameter optimization, closed-loop experimentation with decision making under uncertainty, and semi-autonomous and autonomous experimentation.

18. The method of claim 14, wherein collecting characterization data comprises obtaining measurements of UV-Vis reflectance absorbance and/or modular photoluminescence of material on the substrate.

19. A non-transitory computer readable medium storing executable instructions that when executed by at least one processor of a computer control the computer to perform operations comprising:
selectively rotating a spinner on which a substrate is positioned;
selectively operating an arm assembly to position one of a plurality of material dispensers over a center of the substrate; and
dispensing material from the one of the plurality of material dispensers to the substrate.

20. The non-transitory computer readable medium of claim 19, wherein selectively operating the arm assembly comprises operating a servo to rotate the one of the plurality of material dispensers into a position over the center of the substrate.
